(19) United States
(12) Patent Application Publication
(10) Pub. No.: US 2010/0258056 A1
(43) Pub. Date: Oct. 14, 2010

(54) GIZMO COMFORT STATION

(76) Inventor: Kee Seon HONG, Goyang-Si (KR)

Correspondence Address: BIRCH STEWART KOLASCH & BIRCH, PO BOX 747, FALLS CHURCH, VA, 22040-0747, US

(21) Appl. No.: 12/756,797

(22) Filed: Apr. 8, 2010

(30) Foreign Application Priority Data
Apr. 9, 2009 (KR) 10-2009-007189-8

(51) Int. Cl. A01K 29/00

(52) U.S. Cl. 119/163; 119/167

(57) ABSTRACT

The present invention relates to a Gizmo Comfort Station, an animal toilet which automatically cleans and collects animal excrements; the Gizmo Comfort Station allows animals to relieve in a flexible schedule, and relieves humans/owners from daily pet waste cleaning and allows a sanitary way of cleaning and collecting excrements.

The Gizmo Comfort Station comprises of a toilet body having an excrement receptacle space and an opening for extending to the excrement receptacle drawer; step plate covers, for moving left/right from the center of the opening of the toilet body in order to open/close the opening; a cover driving unit, which is positioned in the toilet body, for driving the step plate covers in a left/right direction; and an excrement transfer apparatus, which is installed at both sides of the toilet body, for moving excrements of pet animals towards an end of the step plate cover in order for excrements to drop into the excrements receptacle drawer. The sensor detects pet animals or humans and sends out signals to the central processing unit to start the operation of the cleaning process.

In the present invention, pet animal excrement is automatically disposable, and the step plate cover can be managed in a sanitary way. Specially, by collecting animal excrement to the excrement collecting bag, which is bio-degradable and by sealing the opening of the collecting bag, the invention prevents odors from spreading and excrements can be disposed in a more sanitary way. The step plate cover is sanitized and cleaned by the sterilizer. In addition, the invention is capable of recording and outputting voice/sound such as an owner's compliment in case the pet animal uses the Gizmo Comfort Station.

### CROSS-REFERENCE TO RELATED APPLICATIONS

This U.S. National stage application claims priority under 35 U.S.C. §119(e) to Korean Patent Application No. 10-2009-0030715, filed in the Republic of Korea on Apr. 9, 2009, the entire contents of which are hereby incorporated herein by reference.

### BACKGROUND

### Field

The present application relates to a Gizmo Comfort Station, an automatic animal toilet for receiving excrement of domesticated animals, captive animals and pets.

In the past, a house pet such as a dog or a cat is let to excrete on newspaper or a used paper or litter pan. Otherwise, a pet is trained to excrete on a certain position such as a balcony, bathroom or outdoors. However, the ways of disposing excrements are very unsanitary and inconvenient. Zoo stalls and livestock housing ways of cleaning and disposing excrements are human task oriented and time consuming and unsanitary as well.

Generally, a pet toilet comprises of an excrement container with an upper opening, and a step plate, on the excrement container, on which a pet stands in order to excrete.

FIG. 1 shows a structure of a conventional pet toilet. As shown in FIG. 1, the step plates(1) form a grid shape. The plates(1) are located side by side, and are connected to each other by a linkage apparatus such as a gear so that all the plates are rotated when one of the plate is rotated, thereby intervals between the plates are changed according to a rotation angle. In the conventional pet toilet, when the plates which are horizontal are rotated by about 90°, intervals between the plates(3) are increased so excrements of pet on the step plate falls to an excrement container through an increased space between the plate(3).

However, the conventional pet toilet has a complex structure for driving the plates (3), so it is difficult to make the pet toilet and causes frequent failure.

In addition, in case a size of excrement is larger than the increased space between the plates 3, or in case excrement of pet is put across the space or its viscosity is too high, fall to the excrement container is not performed smoothly, thereby causing difficult disposal problems and the step plate(1) and the excrement container is easily dirtied.

The excrement container of the conventional pet toilet does not contain any collecting bags. The excrement container covers the whole step plate(1) area, where pets step onto to excrete, therefore the wide excrement container poses difficulty in disposing; excrements are left exposed to air until the container is emptied.

### SUMMARY

An objective of the present invention is to provide a toilet which is capable of automatically and mechanically cleaning, collecting and disposing of excrements of various animals that are domesticated or in captivity. These animals can include livestock, pets, zoo animals and more. This invention can vary in size and shape depending on animal type and usage situations.

For the purposes of explaining, Gizmo Comfort Station can be also called automatic animal toilet or toilet.

General use of this invention is for pet animals; therefore the explanation will base the invention on pet animals.

The Gizmo Comfort Station is portable and can be installed as a fixed fixture depending on animal type and situations. The Gizmo Comfort Station is used in places where animals excrete such as livestock housing, zoo stalls, houses and more.

If the Gizmo Comfort Station is installed as fixed, for zoo stalls or livestock housing, the toilet will be built into the structure of the building and step plate covers(20) and the operation can be altered to adjust to the building and usage situations. Also, the zoo animals or livestock excrements collected can be recycled for appropriate uses such as fuel or compost, therefore the excrement collecting bag can be optional to use.

The toilet is generally rectangular in shape to fit spaces indoors or outdoors. Other shapes such as circular shapes can be used. If a circular shape is used, the step plate covers(20) rotate in a circular motion horizontally, and the air blower housing unit(42) moves towards the center or is positioned on top of the step plate covers(20).

Although not shown, the user interface display panel allows humans to input sound/voice, set timing, power on/off, reset button, and other options to control the operation of the toilet.

The embodiment of the present invention provides a toilet comprising: a toilet body(10) having an excrement receptacle drawer(55) and an opening(12) for extending to the excrement receptacle space (11); a step plate cover(20) for moving left/right from a center of the opening of the toilet body(10) in order to open/close the opening(12); a cover driving unit(30), which is positioned in the toilet body(10), for driving the step plate(21) in a left/right direction; and an excrement transfer apparatus(40), which is installed at both sides of the toilet body(10), for moving excrement of a pet animal toward an end of the step plate(21) in order to drop the excrements into the excrements receptacle space(11).

The step plate cover(20) is provided with grooves(22) thereon which are parallel with a movement direction of the step plate cover(20). The step plate cover consists of left step plate cover(20L), and right step plate cover (20R). These two step plate covers uses the guide track

Another embodiment of the present invention provides a toilet comprising: a toilet body(100) having an excrement receptacle drawer (155) and an opening(112) for extending to the excrement receptacle space(111); a step plate(121), inclining upwards in order for the excrements to move towards the excrement receptacle space(111) of the toilet body(100); a cover driving unit, which is positioned in the toilet body(100), for rotating the step plate(121); and an excrement transfer apparatus(140), for moving excrements of animals toward an end of the step plate(121) in order to drop excrements into the excrement receptacle drawer(155).

A top surface of the excrement transfer apparatus(140) corresponds to the top surface of the step plate(121) in completion of motion and before motion. The excrement transfer apparatus(140) moves upwards and follows the track guide(145) paralleling the step plate(121).

The excrement transfer apparatus(40,140) comprises: a housing space(14); an air blower(41), which is positioned in the housing space(14) or the toilet body(10,100), for blowing air to the housing or towards the center of the step plate(21,121); and a sterilizer(50), which is in front of the air blower(41), for spraying sterilizing/sanitizing liquid onto the step plate(21,121).

The excrement transfer apparatus(40) further comprises a transfer apparatus driving unit which includes rack(31), pinion(32), linear motor or pneumatic cylinder, in order to move forward/backward on the step plate cover(20).

The toilet body(10,100) further comprises a sensor(70,170) for sensing a pet animal and applying a driving signal for the cover driving unit(30) to activate followed by activating the excrement transfer apparatus(40,140), air blower(41), sterilizer(50) and heat adhesion unit(65).

The toilet body further comprises an excrement receptacle drawer(55, 155) and an excrement collecting bag(60) which is bio-degradable.

The toilet body further comprises a heat adhesion unit(65), located above the excrement receptacle drawer(55), heat-adheres and seals the excrement collecting bag(60).

In FIG. 4, the heat adhesion unit(65) comprises of two heat applying sealers(66), which is located at both sides of the excrement collecting bag(60), for moving towards center in a left/right direction and having a heat applied; a compressor(67), which is located at opposite sides of the heat applying sealers(66), moves forward/backwards towards center in order to close up the opening of the excrement collecting bag(60) before the heat applying sealer(66) moves towards center to seal from the opposite sides of the of the excrement collecting bag(60).

The toilet body further comprises a ramp(80) which is detachable and can be connected to the toilet body in order to provide easier access from the floor onto the step plate(21).

The toilet body further comprises a detachable wall(85) that is placed vertically on to the toilet body in order to prevent pet excrements from spattering in case of a male pet.

In the present invention, pet animal excrement is automatically disposable, and the step plate cover can be managed in a sanitary way. Especially, by collecting pet excrements to the excrement collecting bag, and by sealing it, excrements can be disposed in a more sanitary way. In addition, the invention is capable of recording and outputting voice such as an owner's compliment in case the pet animal uses the pet toilet.

This invention alleviates the daily task of cleaning animal excrements for more comfort to owners of the animals, allows a flexible schedule for animals to excrete and a more faster and sanitary way of collecting and disposing of excrements.

### BRIEF DESCRIPTION OF THE DRAWINGS

The above and other features and advantages of the present invention will become more apparent to those of ordinary skill in the art by describing in detail preferred embodiments thereof with reference to the attached drawings, in which:

FIG. 1 is a cross sectional view for showing a part of a conventional pet toilet;

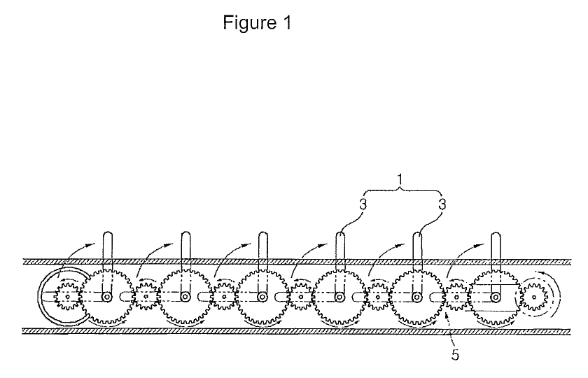

FIG. 2 is a perspective view of showing the pet toilet according to a first embodiment of the present invention;

FIG. 3 is a cross sectional view of the Gizmo Comfort Station.

FIG. 4 is the view is showing the heat adhesion unit in the Gizmo Comfort Station.

FIG. 5 is a perspective view of showing a mounted wall and detachable ramp of the Gizmo Comfort Station;

FIG. 6 is a perspective view of showing operation of the step plate cover and excrement transfer apparatus.

FIG. 7 is a cross sectional view showing the operation of the excrement transfer apparatus, air blower, and sterilizer.

FIGS. 8a-8b are views of showing the operation of the heat adhesion unit in the Gizmo Comfort Station; compressor and heat applying sealer seals the excrement collecting bag.

FIG. 9 is a perspective view of showing the Gizmo Comfort Station according to the second embodiment of the present invention;

FIGS. 10 and 11 are cross sectional views of showing an operation of the Gizmo Comfort Station according to the second embodiment of the present invention.

FIG. 12 is a perspective view of showing the Gizmo Comfort Station according to a third embodiment of the present invention;

FIGS. 13 and 14 are perspective views of the operation of the toilet according to the third embodiment; operations of the step plate covers are shown.

FIG. 15 is a perspective view of showing the operation of the excrement transfer apparatus according to the third embodiment.

FIGS. 16 and 17 are perspective views of the operation of the collecting bag driving unit operating the excrement collecting bag according to the third embodiment.

### DETAILED DESCRIPTION OF THE PREFERRED EMBODIMENTS

Above all, a theoretical background relating to the present invention is described in detail with respect to appended drawings.

### First Embodiment

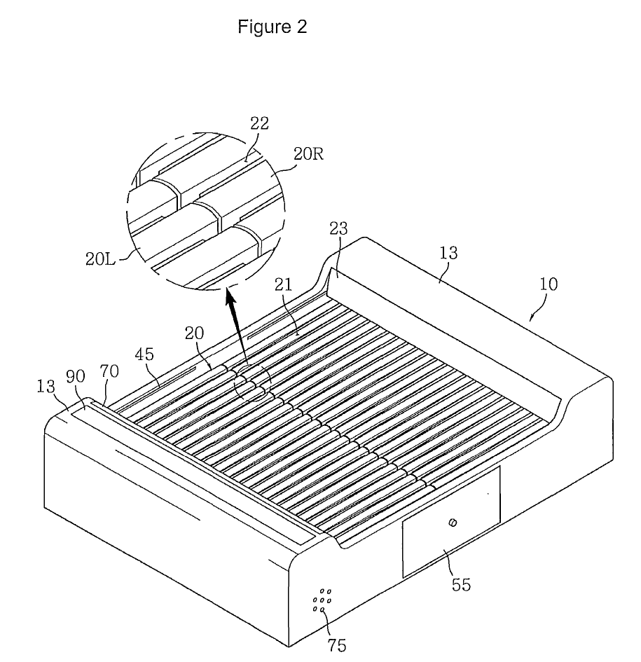

FIG. 2. through 8 is showing the first version sample of the invention.

A Gizmo Comfort Station according to an embodiment of the present invention comprises a toilet body (10), step plate cover (20) which has a left step plate cover(20L) and right step plate cover(20R) which uses the step plate track guide(25) to move left and right horizontally to create an opening(12). The projecting portion (13) is a casing for the excrement receptacle space(11). Pet animals step onto the step plate(21) which has grooves(22). The grooves(22) end short of the step plate(21), creating an opening (12) where the center of the step plate covers(20L,20R) meet. The step plate(21) is horizontally parallel to the ground, however the grooves(22) are sloped downwards towards the center opening(12) in order for the liquid excrements to incline downwards and fall into the excrements receptacle drawer(55). A display panel(90) is embodied in the projection portion(13) along with the sensor(70).

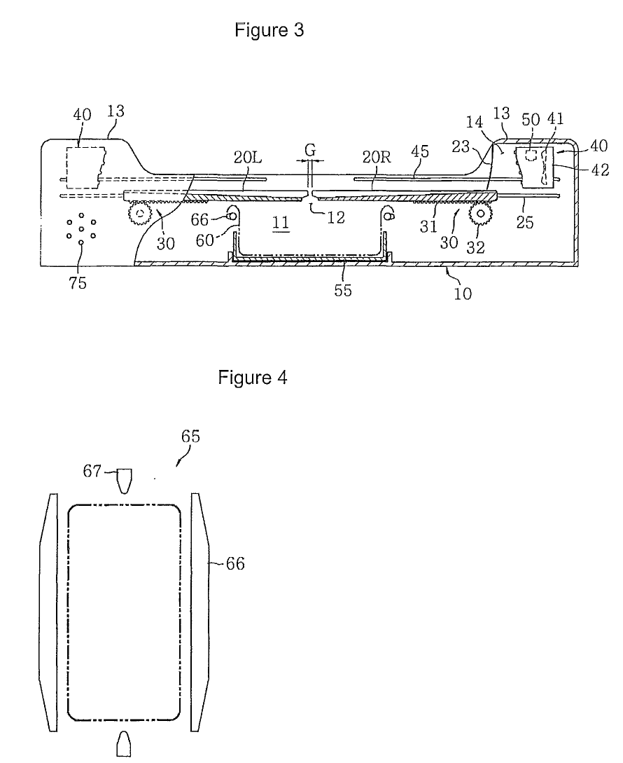

FIG. 3. The cover driving unit(30) moves the step plate covers(20). Bottom of the step plate covers(20) is the rack(31) that has teeth that fits with the pinion(32). The pinion(32) couples with the rack (31), and is fixed on a drive shaft of the fixed driving motor. The rack(31) is installed parallel to the step plate cover(20). As the pinion(32) rotates by a motor, the step plate covers(20) slide away from each other creating an opening(12).

The motor is held by a bracket inside the toilet body(10) and the pinion(32) is directly connected to the motor; there are two motors for each pinion. Other option is to use a device that can deliver power and rotation to each pinion. This device can be a belt, chain or other means.

The cover driving unit(30) changes the rotation movement of the driving motor to a linear reciprocating movement, and the driving unit is not limited to the rack(31) and the pinion(32) and otherwise a linear motor, etc can be used.

The cover driving unit (30) can be installed at both sides of the bottom of the step plate cover (20L,20R) or it can be installed at one side and a roller at the other side to move together by a rolling contact.

An excrement transfer apparatus(40) is installed in the projecting portion(13) of the toilet body and moves the excrement towards the end of the step plate cover(20) by pneumatic through a housing hole(23) in an internal side wall of the projecting portion(13) to drop the excrement into the excrement collecting bag(60). The excrement transfer apparatus comprises of a air blower housing(42), an air blower (41) and a sterilizer (50).

The cover driving unit(30) can include rack(31), pinion(32), instead of a motor, a linear motor, or pneumatic cylinder and other means can be used.

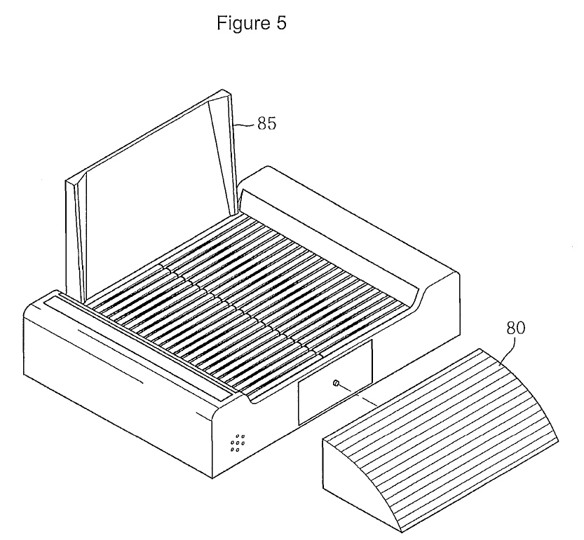

In addition, there is a central processing unit that controls the function, operation and sequencing of the step plate covers(20L, 20R), excrement transfer apparatus(40), sterilizer(50), air blower(41), excrement receptacle drawer(55), excrement collecting bag(60), heat adhesion unit(FIG. 4, 65), cover driving unit(30), sensor(70), sound input/output unit(75).

There are two excrement transfer apparatus(40), both equipped with air blower(41), air blower housing(42) and housing moving apparatus (not shown). The solid excrement on the step plate(21) is moved into the excrement collecting bag(60) by the air produced by the air blower(41).

The toilet body (10) further comprises of a sensor(70) for sensing a pet animal or human that sends signals to the central processing control unit. The sensor(70) uses motion detecting infrared sensor method, which is placed on projecting portion(13) heading the step plate(21) direction. The sensor(70) can also be a weight sensor instead of a motion detecting infrared sensor. The sensor(70) stops the cover driving unit(30) by the central processing control unit when a sense signal for pet animal or human is outputted while applying a driving signal to open the step plate covers(20). The toilet can be stopped at any moment, if the sensor(70) detects pet animal or human within the sensor range while toilet is operating. By stopping the operation when pet animal or human is detected within the sensor zone, it prevents accidents from happening.

The central processing control unit sends the signal to resume the operation after the sensor has not detected any movement of pet or humans in range of the sensor.

The excrement transfer apparatus(40) receives a drive signal by a central processing control unit in case the sensor(70) does not sense a pet animal.

The housing hole(23) of the projecting portion(13) may be provided with a curtain (not shown) which moves up in case of a forward movement of the excrement transfer apparatus(40).

The air blower housing(42) is placed inside the housing space(14) at both ends of the toilet body. Air blower housing(42) is provided at its front with a hole or nozzle, and moves left/right by a excrement transfer apparatus(40), and includes the air blower(41) and the sterilizer(50). The air blower(41) inside the housing(42) blows air towards the center of the step plate covers(20) and produces enough pneumatic air pressure to move excrement of pet animal and drop it into the excrement collecting bag(60).

The sterilizer(50) is positioned in front of the air blower(41), and provides sterilizing material to air from the air blower(41), thereby sterilizing a surface of the step plate covers(20) which pet excrements have contact. The spraying of sterilizing material can also work separately from the air blower(41); the air lower can operate first, then the sterilizing material can be sprayed onto the step plate(21). The sterilizer(50) can also embody a germicidal lamp such as UV ray to sterilize the step plate(21).

The air blower(41) and the sterilizer(50) may be installed in the toilet body(10) connected to the air blower housing(42) through a connection pipe so that the air blower housing(42) is capable of discharging sterilized air provided from the air blower(41) and the sterilizer(50).

The excrement transfer apparatus(40) drives in the same direction as that of the step plate covers(20), and may be similar to the cover driving unit (30).

In other words, the excrement transfer apparatus(40) is provided with a rack(31) at both internal walls, and a pinion(32) fixed to a drive shaft of a drive motor; it is fixed to both ends of the air blower housing(42). The drive motor is connected to the central processing control unit to control the driving.

The central processing control unit controls the driving of the heat adhesion unit(65), the cover driving unit (30) and the excrement transfer apparatus(40), and an operational display panel(90) which includes control display of showing control states are included in the toilet body(10) in order to help a user select an operation state such as power on/off and blowing magnitude of the excrement transfer apparatus(40), sound/voice recording options, and timer options for the cleaning process to begin.

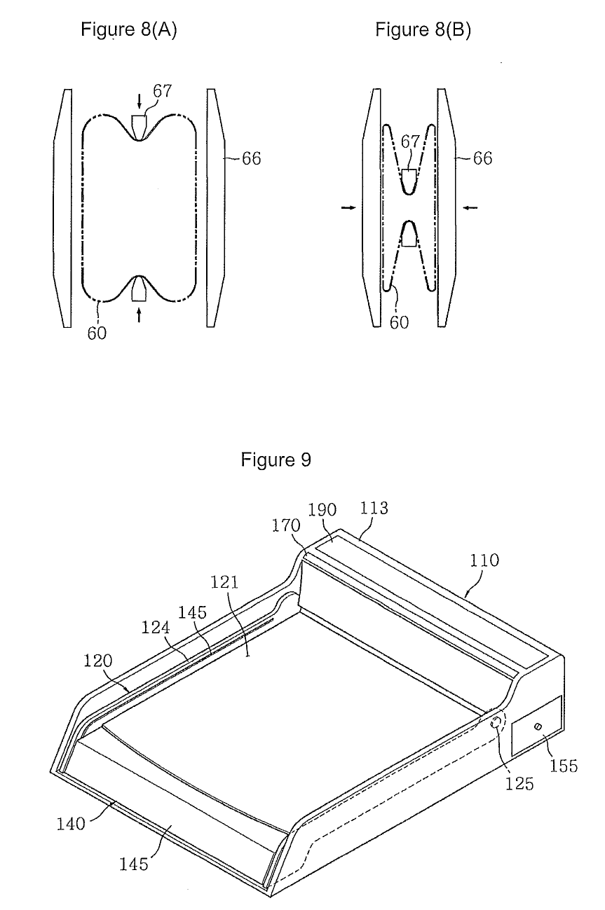

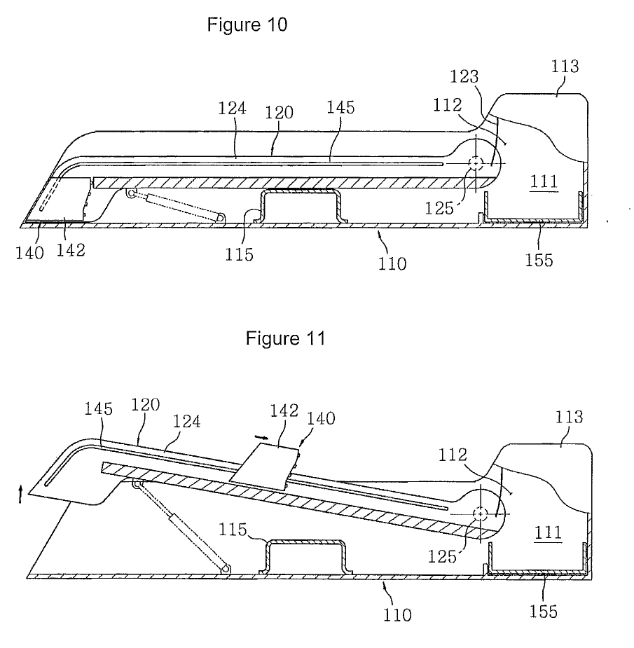

An operation of the Gizmo Comfort Station according the first version is as follows as Shown in FIG. 2-FIG. 8b.

When the Gizmo Comfort Station is in a normal, inactivated position, the opening(12) is closed, air blower(41) and sterilizer(50) are in an inactive position. Air blower housing(42) is positioned inside the housing space(14) and the heat applying sealer(66), compressor(67) which is part of the heat adhesion unit(65) is in an inactive position inside the toilet body. The sound input/output unit(75) outputs when it is activated.

When a pet animal steps up to the step plate(21) to excrete, the sensor(70) senses the animal, and the central processing control unit outputs a timed signal for the cleaning process to start.

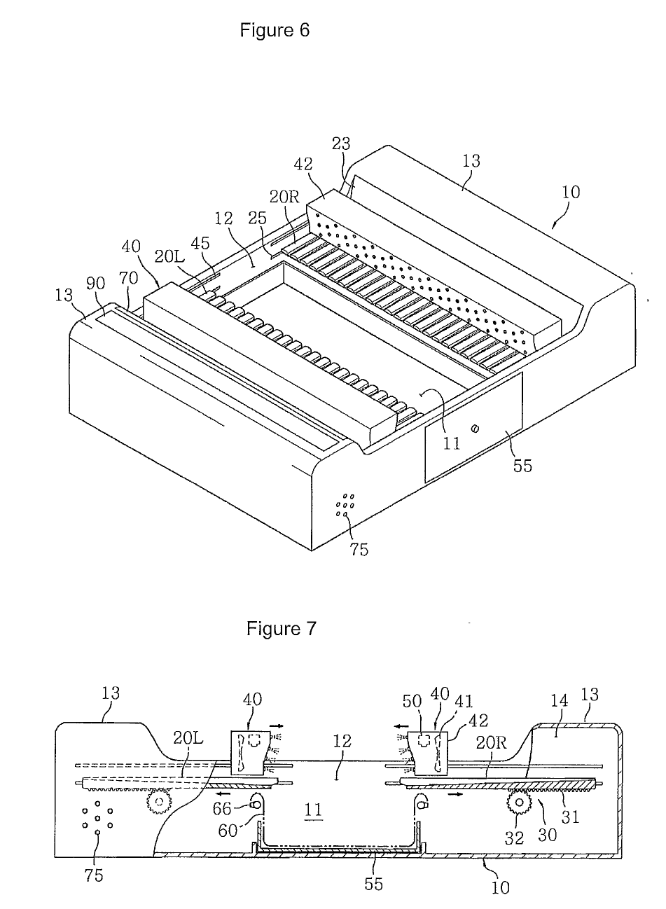

FIG. 5, the toilet body(10) further comprises of a ramp(80), which is detachable and can be connected to the toilet body between the projection portion(13) and on the side for forming a passage from the floor. The ramp(80) is for helping a small size pet animal to step onto the step plate(21) for excreting.

The toilet body(10) further comprises of a wall(85) (FIG. 5) for mounting onto the toilet body(10) between the projecting portions(13) in order to prevent pet excrement from spattering, specially in case of a male pet.

When the pet animal finishes excreting or while excreting, a recorded voice of a pet owner's such as compliment or training sounds such as clicking sound is outputted from the sound input/out unit(75) so that the pet animal can recognize the use of toilet as compliments. Other compliment methods such as outputting a treat/food can be used. In addition, one can use pet animal attracting substances such as pheromone spray on the step plate(21) to attract pet animals to excrete on the step plate(21) or train pet animals to use the pet toilet.

When the sensor(70) detects that the animal has exited the step plate(21), the central processing control unit decides if the animal excreted liquid waste or solid waste by timing and sensing. Accordingly, the central processing control unit transmits signals to the step plate covers(20), excrement transfer apparatus(40), cover driving unit(30) and heat adhesion unit(65).

When the pet excretes liquid waste on the step plate covers(20), liquid waste moves toward the center of the opening(12) along the grooves(22) of the step plate covers(20L,20R), and is collected through the gap between the left step plate cover(20L) and the right step plate cover(20R). In case the pet animal excretes only liquid waste, the air blower(41) and the sterilizer(50) are operated to sterilize the surface of the step plate(21) without the step plate covers(20) operating.

If it was solid waste, the process begins with opening of the step plate covers(20L,20R) in left/right direction by the cover driving unit(30) and creating an opening in the center. Then, the air blower(41) of the excrement transfer apparatus(40) discharges compressed air to move and drop pet excrements on the step plate(21) through the opening(12) to the excrement collecting bag(60) in the excrement receptacle drawer(55).

The compressed air from the air blower(41) also has a sterilizing material from the sterilizer(50) to sterilize the surface of the step plate(21). The air blower housing(42) moves towards the center of the opening while the air blower(41) discharges air. The compressed air may discharge first then the excrement transfer apparatus(40) resets and backs up then the sterilizer(50) activates and sprays while the air blower housing(42) is moving towards the center of the opening. Another option is the air blower(41) discharges both air and sterilizing material simultaneously while the air blower housing(42) is operating towards the center opening.

Once the pet animal excrement is collected in the excrement collecting bag(60) in the excrement receptacle drawer(55), the opening of the excrement collecting bag(60) is heat-adhered by the heat adhesion unit(65).

According to the operation, the excrement transfer apparatus(40) transfers the excrement to the collecting bag(60) by air pressure, therefore there is no contact with the excrement and the excrement transfer apparatus(40). The step plate(21) is sanitized by the sterilizer(50) thereby maintaining a clean environment.

The compressor(67) has two bars, and both bars move towards each other by the bar driving unit to fold and gather the opening of the excrement collecting bag(60). Then, the heat applying sealer(66) positioned at opposite sides of the compressor(67) is moved forward to the excrement collecting bag(60) to fold and heat-adhere and seal the opening of the collecting bag(60).

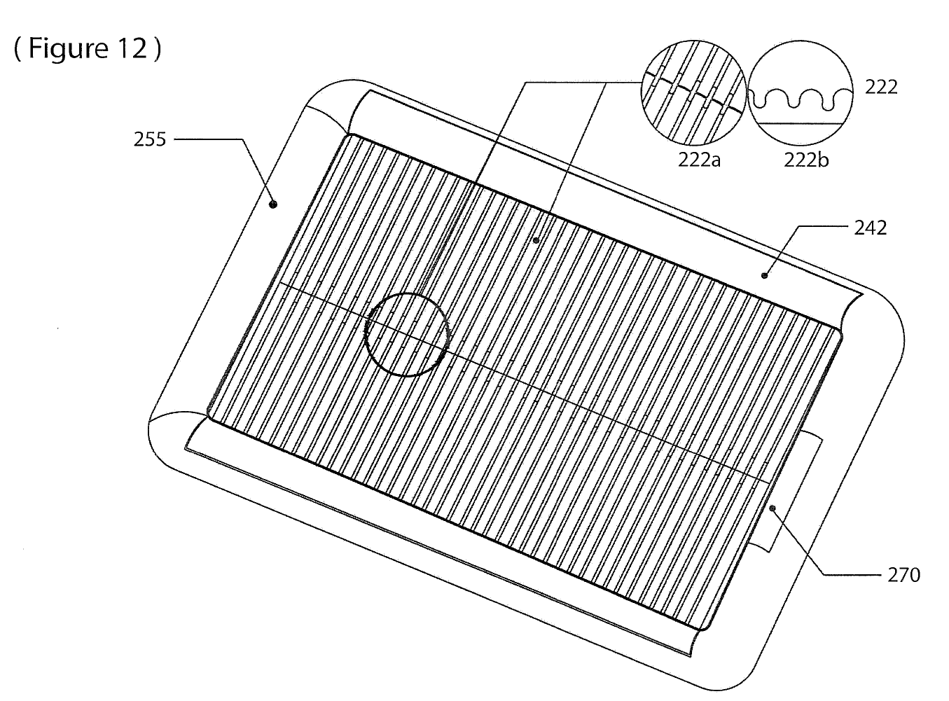

As shown in FIG. 8a-8b and FIG. 4, the heat adhesion unit(65) heat-adheres the opening of the collecting bag(60). The excrement collecting bag(60) is folded and gathered, therefore preventing defects such as partial sealing of bags. Sealing the excrement collecting bag(60) prevents odors from spreading and maintains a sanitary disposal method.

Then, the central processing control unit after a certain time (or when the control unit senses a removal of excrement), the cover driving unit(30) moves the left and right step plate covers(20R,20L) inwardly to its original position, and the excrement transfer apparatus(40) moves the left and right air blower housing(42) outwardly to its original position into the housing space(14).

Next, a human pulls out the excrement receptacle drawer(55) in the excrement receptacle space(11) and removes the sealed collecting bag(60) and put back the excrement receptacle drawer(55) in the receptacle space(11).

The excrement receptacle space(11) has an excrement receptacle drawer(55) of a drawer shape for receiving excrements of pet animal, and a heat adhesion unit(65) (FIG. 4), which is located in the upper part of the excrement receptacle drawer(55), for heat-adhering a collecting bag(60) of bio-degradable material in the excrement receptacle drawer(55).

In side walls of the toilet body(10), a step plate track guide (25) (FIG. 2) is formed into which the step plate covers(20) is inserted in order to guide the step plate covers(20).

### Second Embodiment

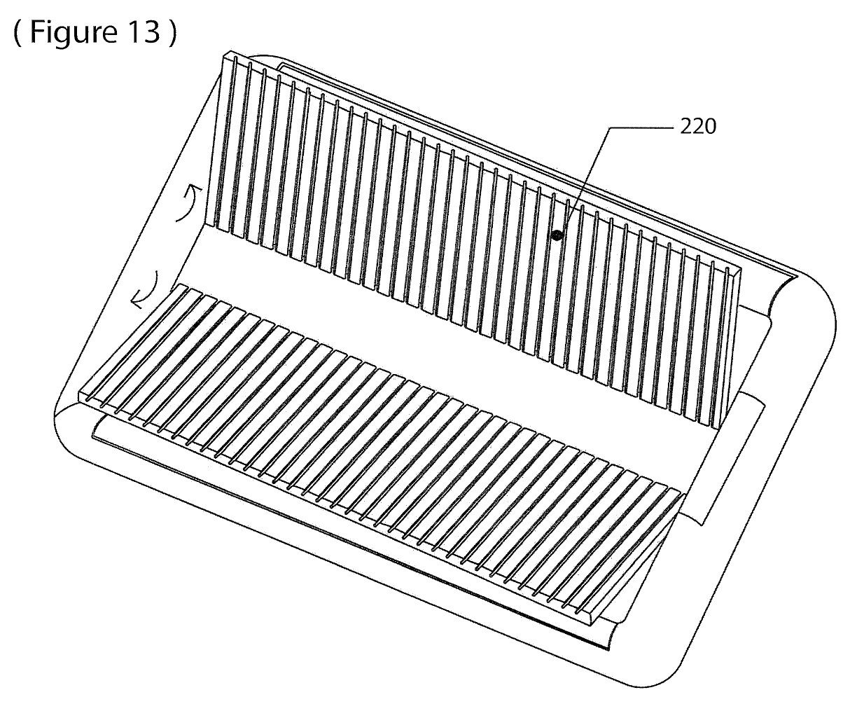

A Gizmo Comfort Station according to a second example of the present invention is shown in FIG. 9 through 11.

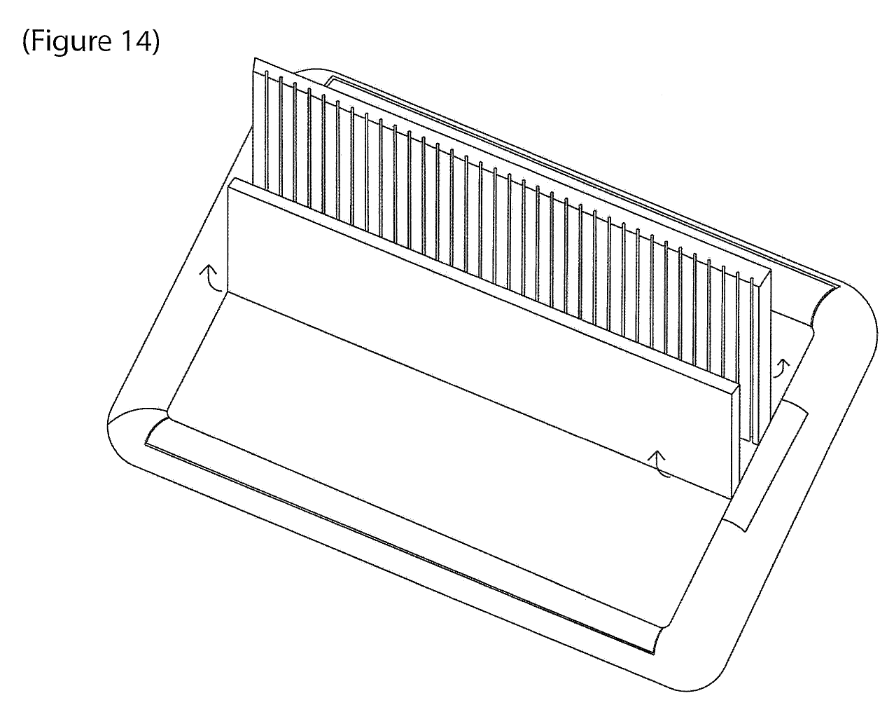

The differences between the first embodiment and the second embodiment is that the step plate(FIG. 9, 121) angle can be adjusted and controlled making a slope. Also, the housing opening(FIG. 10-11, 112) is positioned at one end below the step plate(121) when the step plate(121) is in a sloped position. The animal excrement follows the sloped angle of the step plate(121) towards the housing opening(112) and falls into the excrement receptacle space(111) and into the excrement receptacle drawer(155).

According to the second embodiment, the invention comprises a toilet body(110), a step plate(121), rotation unit(120), rotation unit driving device(not shown) an excrement transfer apparatus(140).

The toilet body(110) is provided with a projecting portion(113) at a top end of either right or left side thereof and is provided with an excrement receptacle space(111) and an housing opening(112) which leads to the excrement receptacle space(111) at an internal side wall of the projecting portion(113).

The rotation unit(120) has a hinge(125) positioned on one end that allows the rotation unit(120) to slope up and down. The rotation unit(120) has a flat surface which a pet animal can use as a step plate(121). The step plate(121) is positioned on top of the rotation unit(120). This step plate(121) does not interfere with the movement of the rotation unit(120) and aligns with the housing opening(112).

The rotation unit(120) is provided with a long rib(124) at each sides which are opposite to the movement direction of excrement, and provided with a guide track(145) for guiding a movement of the excrement transfer apparatus(140)(in the side wall of the rib). An end of the guide track(145) is formed in a curve shape where the top surface of the excrement transfer apparatus(140) corresponds to the top of the step plate(121).

Air blower, Air blower housing(142)'s discharge structure and operating methods are similar to the first version example, and is explained in the above paragraphs, therefore the explanation will be omitted.

The air blower housing(142) has a guide track(145) that is positioned on the outer side of the rib(124) on both sides. The sides of the air blower housing(142) is able to slide inside the guide track(145).

The guide track groove is positioned moving towards the opening(112) then coming back to the other end where the air blower housing(142) sits at it's inactivated position (opposite side of hinge(125)). After the air blower housing(142) has operated, it retreats back to it's original position following the guide track groove leveling up with the step plate(121). So, the air blower housing(142)'s top surface is leveled with the step plate(121) when in the original position.

The excrement receptacle drawer(155), control measures and display panel(190). Control measures include sensor(170) and central processing control unit(not shown). The excrement receptacle drawer(155) and sensor(170) is same as the first version, therefore the explanation is omitted. The central processing control unit will be explained in the operation part, therefore the explanation is omitted.

In addition, although not shown, same as first embodiment and second embodiment sample has a sterilizer(50), excrement collecting bag(60), heat adhesion unit(65), sound input recorder, sound input/output unit(75), ramp(80) and wall(85). The configurations and operations of these of version 1 is the same as version 2, therefore the explanation is omitted. However, the wall(85) needs to be installed in a way where the rotation unit(120) is not interfered when in operation.

The operation of the Gizmo Comfort Station according to the second embodiment is as follows. Similar operations of first embodiment and second embodiment are omitted.

When the Gizmo Comfort Station is in a normal, inactivated position, the rotation unit(120) is in a horizontal leveled position, air blower(41) and sterilizer(50) are in an inactive position. Air blower housing(42) is positioned at one end of the rotation unit(120) and is coplanar with the rotation unit(120) level.

When a pet animal steps up to the step plate(121) to excrete, the sensor(170) senses the animal, and the central processing control unit outputs a timed signal for the cleaning process to start. The second embodiment rotation driving unit(130) and excrement transfer apparatus(140) is operated as follows.

FIG. 11, Rotation driving unit(130) drives the rotation unit(120) in a certain angle based on the hinge(125). The step plate(121) becomes sloped downwards to the housing opening(112).

When the step plate(121) is inclined downwards to the housing opening(112), liquid waste of a pet animal naturally moves through the housing opening(112) and the excrement receptacle space(111) and into the excrement receptacle drawer(155). (If there is a collecting bag in place, the excrement is collected inside the collecting bag.) The solid waste can be moved into the excrement receptacle drawer(155).

FIG. 11, when the step plate(121) is inclined downwards, the air blower housing(142) moves towards the housing opening(112) by the of the excrement transfer apparatus(140). The air blower housing(142) discharges compressed air and sterilizing material to drop pet excrement through the housing opening(112) into the excrement receptacle drawer(155). Afterwards, the air blower housing(142) moves towards the end of the rotation unit(120)(FIG. 9, 10) to the original leveled position.

The signs not explained in FIG. 9 through 11 are support part(115) and sheet(123). Support part(115) supports the rotation unit(120) when it is in the original position parallel to the ground. This support part(115) is positioned across from the projecting portion(113) inside the toilet body(110).

As in the first embodiment, the flexible sheet(123), functions like a curtain. This sheet(123) is covering the housing opening(112) and is lifted and closed when the rotation unit(120) is operating.

### Third Embodiment

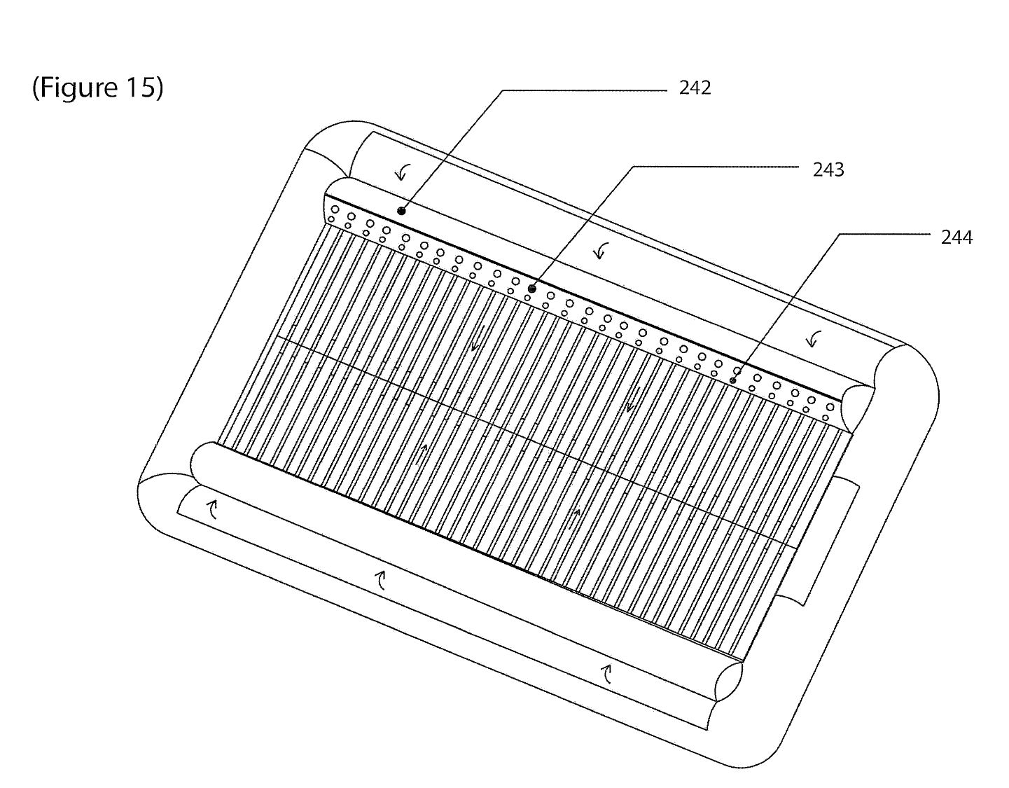

FIGS. 12-18 shows the third embodiment of the toilet.

The third embodiment adds movement to the excrement collecting bag, how the step plate covers operate and the variation on the step plate cover grooves. Also, the central processing control unit can be programmed by a user interface display panel.

Other minor differences include the air blower housing unit positioning, the general toilet body structure, and adding the usage of animal excretion attracting material. According to the animal type and size, the toilet structure can be altered.

FIG. 12, drawing illustrates the basic construction of the automatic animal toilet invention.

FIG. 12, 222a-b represents the step plate in detail; step plate is grooved, so when an animal steps onto the pad and excretes liquid waste, the feet (ex: paws, hooves) will not soak or get wet. The slope of the lower part of the grooves(222) where liquid waste collects is sloped downwards towards the center of the two step panels meet. This allows the liquid waste to collect towards the center by gravity.

FIG. 12, 222a, the enlarged views illustrate the opening in the grooves where two step plate covers(220) meet. This opening is for draining of the liquid waste collected by the grooves.

FIG. 12, 222b illustrates the sliced view of the grooves. The grooves are smooth for easy cleaning and safety measures. The sensor(270) is inset in the toilet body; the function is the same as variation 1 and 2, therefore the explanation is omitted.

The air blower housing unit(242) is also inset in the body of the toilet when in original position. The air blower housing unit(242) is located on both sides of the step plate covers(220). The excrement receptacle drawer(255) is on one side of the toilet body and can slide out.

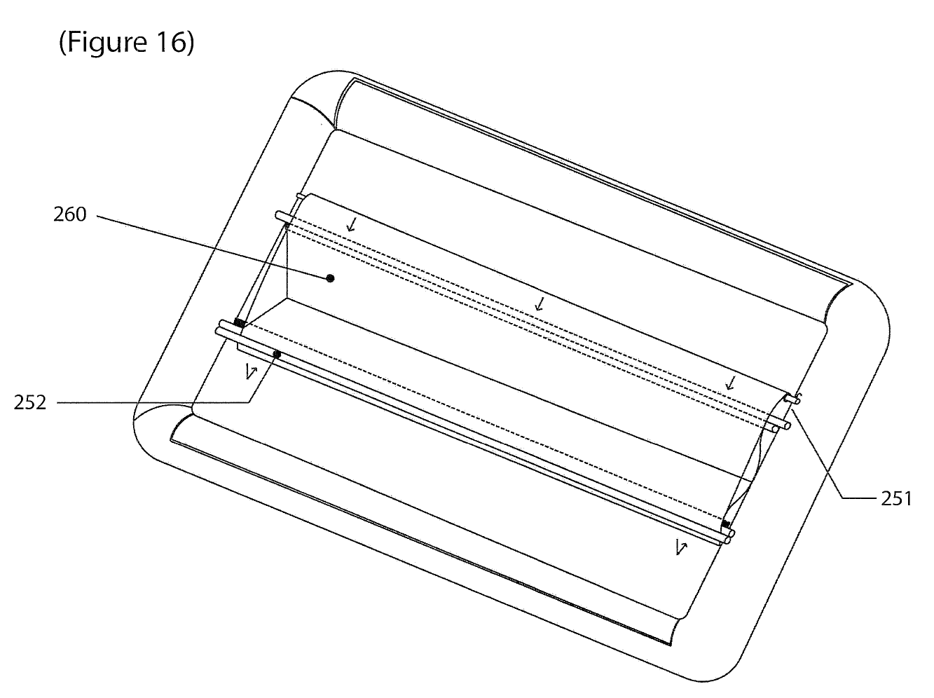

FIGS. 13 and 14, illustrates the operation of the step plate covers(220). The step plate covers(220) slide sideways away from the center parallel/horizontally and slide upwards until they are perpendicular creating an opening in the center. The solid waste on the step plate covers(220) will fall into the opening and into the excrement collecting bag(260). The step plate covers are operated by the cover driving unit(not shown). The step plate covers(220) slide back to the original leveled position after a certain time from the perpendicular position.

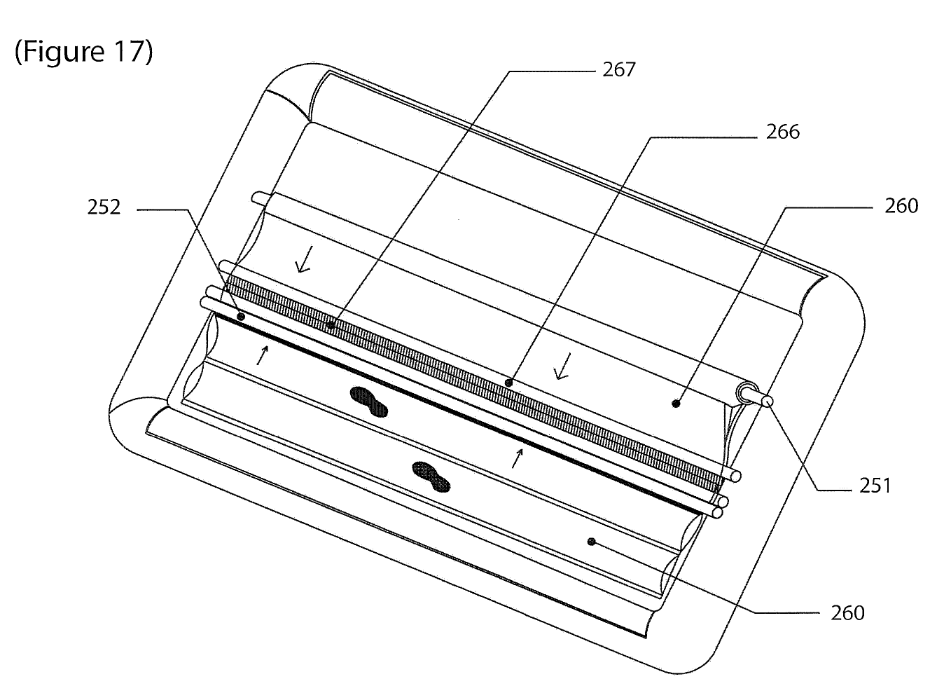

FIG. 15, illustrates the operation of the air blower housing unit(242), sterilizer and the air blower which is driven by the excrement transfer apparatus. The air blower housing unit(242) moves towards the center of the step plate covers(220); the air blower housing units(242) either move up and slide parallel to the step plate covers(220) or the air blower housing unit(242) rotates to reveal the air blower nozzle(243) and sterilizer nozzle(244) towards the center of the toilet body, then slides parallel to the step plate covers(220) center.

The air blower nozzle(243) and sterilizer nozzle(244) can be combined, or be separately lined on the air blower housing unit(242) facing the step plate covers in an angle or horizontal way. Other nozzles for animal excretion attracting material can be placed inside the air blower housing or the toilet body.

Another option is to put a UV ray lamp on the air blower housing unit to sterilize the step plate covers(220).

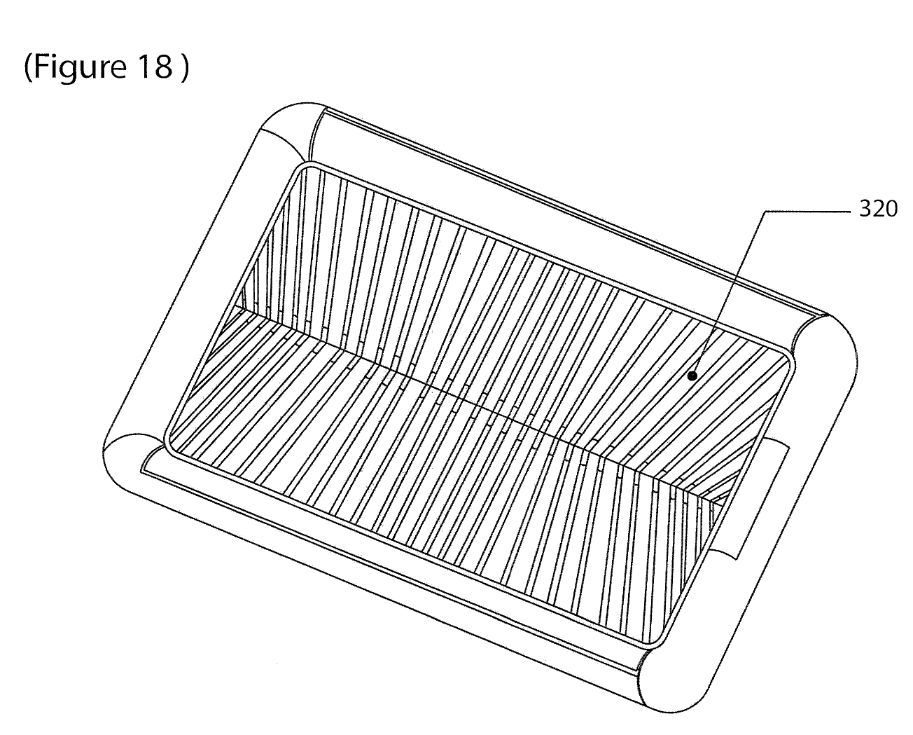

FIG. 16, illustrates the collecting bag driving unit operating the excrement collecting bag(260). The collecting bag driving unit has a roller(251) that rolls the excrement collecting bag(260) in horizontal way in one direction and the bag grabber bar(252) grabs a part of the collecting bag(260) and moves horizontally to open up the folded excrement collecting bag(260).

The bag grabber bar(252) moves towards the roller(251) with one heat applying sealer(266) bar on the side; the bag grabber bar(252) then moves in the opposite direction to open up a space to grab the projecting portion of the bag pocket. The bag grabber bar(252) slips one side of the pocket and tightens the grip by moving to the side of one heat applying sealer(266) then moves away from the roller(251) to open up the folded pocket of the excrement collecting bag(260).

The excrement collecting bag(260) is positioned below the step plate covers(220) in the center area. The excrement collecting bag(260) has pockets that open up when positioned in center of the toilet body, while the bags are connected by main plane that is rolled onto the roller(251).

FIG. 17, illustrates the excrements being collected, and sealed. The excrements collected inside the positioned excrement collecting bag(260) is heat-adhered/sealed by the heat applying sealer(266). The heat blade(267) is on the heat applying sealer(266).

After sealing the excrement collecting bag(260), the bag driving unit drives the roller(251) and the bag grabber bar(252) to operate to position a new pocket bag in the center of the toilet body below the step plate covers(220). The seals bags are connected to each other. The roller(251) is detachable and refillable; detachable by opening the excrement receptacle drawer(255).

FIG. 18, illustrates the variation of step plate grooves(320). The step plate grooves(320) are in a diagonal gathering manner to collect liquid waste towards the center of the step plate covers(220). This step plate groove(320) variation allows the center area to be decreased for a more concentrated area for liquid waste to fall.

This invention is not limited to the examples and explanations and figure drawings of this patent, but can be changed, added and improved according to the range of technology and inventive methods by the inventor.

For example, the sterilizer can be separately functioning from the air blower unit. Either air blower or sterilizer can be positioned inside the toilet body and connected to a tube to the air blower housing providing the air or sterilizing material. Also, the sterilizer can be a UV ray light bar.

Other toilet body shapes and rotation methods and central processing control systems can be used to improve operations. The step plate covers or step plate can be detachable for cleaning.

Variation in materials can be used, such as metal types or plastic types; the toilet body can use recycled plastic, etc.

The functions and operations can vary depending on situations.

1-20. (canceled)

21. A Gizmo Comfort Station comprising:
a toilet body having an excrement receptacle space and an opening for extending to the excrement receptacle drawer;
two step plate covers for moving left/right from the center of the opening of the toilet body in order to open/close the opening;
the pet animal steps onto the step plate covers to excrete;
a cover driving unit, which is positioned in the toilet body, for driving the step plate cover in a left/right direction; and
an excrement transfer apparatus, which is installed at both sides of the toilet body, for moving excrements of pet animals towards the end of the step plate cover in order to drop excrement through the opening into the excrement receptacle space.

22. The Gizmo Comfort Station as set forth in claim 21, where the toilet includes, across from the excrement transfer apparatus, air blowers that blow air.

23. The Gizmo Comfort Station as set forth in claim 22, wherein the excrement transfer apparatus comprises:
an air blower housing;
an air blower, which is positioned in the housing space or the toilet body, for blowing air to the housing or toward a center of the step plate covers which moves left/right parallel to the step plate covers; and
an air blower driving unit that allows the left/right movement of the air blower housing.

24. The Gizmo Comfort Station as set forth in claim 23, further comprising a sterilizer, which is in front of the air blower, for providing a sterilizing material to air or in a separate manner either through the air blower or in a separate nozzle, wherein the sterilizer moves together with the air blower housing to sterilize the step plate covers.

25. The Gizmo Comfort Station as set forth in claim 21, wherein the step plate covers are a pair, left step plate cover and right step plate cover moves from each other and move towards each other to close the opening of the toilet body.

26. The Gizmo Comfort Station as set forth in claim 25, wherein the step plate cover is provided with sloped/inclined grooves thereon which are parallel with the movement direction of the step plate covers.

27. The Gizmo Comfort Station as set forth in claim 21, wherein the excrement falls through the excrement housing space and into the excrement collecting bag; and
the toilet body further comprises a heat adhesion unit, which is located in an upper side of the excrement receptacle drawer, for heat-adhering the excrement collecting bag for collecting excrement falling to the excrement container.

28. The Gizmo Comfort Station as set forth in claim 27, wherein the heat adhesion unit comprises of two compressor bars, which is located at opposite sides of the heat adhesion bar sealers, for moving forward/backward in order to fold and close up the opening of the excrement collecting bag before the heat adhering the opening; and
two heat adhesion bar sealers, which is located at both sides of the excrement collecting bag, for moving in a left/right direction and having a heat line therein head adheres, folds and seals the excrement collecting bag after the compressor bar operates.

29. The Gizmo Comfort Station as set forth in claim 21, wherein the toilet body is further comprised of a ramp which is detachable and is connected to the toilet body side in order to form a passage from the floor.

30. The Gizmo Comfort Station as set forth in claim 21, wherein the toilet body is further comprised of a wall plate for mounting onto the toilet body in order to prevent pet excrement from spattering.

31. The Gizmo Comfort Station as set forth in claim 21, further comprising a sound input/output unit that can record and play sounds/voices.

32. A Gizmo Comfort Station comprising:
a toilet body having an excrement receptacle space and an opening for extending to the excrement receptacle drawer;
a step plate that is for rotating upwards thereof in order to be inclined towards the excrement receptacle drawer of the toilet body;
a rotation driving unit, which is positioned in the toilet body, for rotating the rotation unit and step plate to slope or to a leveled position; and
an excrement transfer apparatus, for moving excrement of a pet animal toward one end of the step plate in order to drop excrement into excrement receptacle drawer.

33. The Gizmo Comfort Station as set forth in claim 32, in the toilet body, the excrement transfer apparatus further comprises a transfer apparatus driving unit in order to move forward/backward on the rotation unit and step plate;
towards the opposite side of the opening, the air blower housing is incased, is able to move up, forwards, backwards and down to the original position.

34. The Gizmo Comfort Station as set forth in claim 32, wherein the top surface of the air blower housing corresponds to a top surface of the step plate in completion of the driving and the original position.

35. The Gizmo Comfort Station as set forth in claim 21, further comprising a sensor for sensing a pet animal or human and applying a driving signal for the operation of the cleaning and containing process to begin.

36. The Gizmo Comfort Station as set forth in claim 21, comprising the collecting bag driving unit which operates the excrement collecting bag. The collecting bag driving unit is comprised of a roller and bag grabber bar; the roller embodies the excrement collecting bags.

37. The Gizmo Comfort Station as set forth in claim 21, comprising the excrement collecting bag which has pockets that open up when positioned in center of the toilet body while the bags are connected by main plane that is rolled onto the roller.

38. The Gizmo Comfort Station as set forth in claim 21, wherein the heat blade is on the heat applying sealer, and the bag driving unit drives the roller and the bag grabber bar to operate and position a new pocket bag in the center of the toilet body below the step plate covers.

39. The Gizmo Comfort Station as set forth in claim 38, wherein the sealed bags are connected to each other, and the roller is detachable and refillable; detachable by opening the excrement receptacle drawer.

40. The Gizmo Comfort Station as set forth in claim 21, comprised of a variation of step plate grooves; wherein the step plate grooves are in a diagonal gathering manner to collect liquid waste towards the center of the step plate covers.
